(19) United States
(12) Patent Application Publication
(10) Pub. No.: US 2015/0336543 A1
(43) Pub. Date: Nov. 26, 2015

(54) WINDSCREEN WIPER DEVICE

(71) Applicant: FEDERAL-MOGUL S.A., Aubange (BE)

(72) Inventor: THOMAS FRISCIONI, AUMETZ (FR)

(21) Appl. No.: 14/646,286

(22) PCT Filed: Nov. 21, 2012
(86) PCT No.: PCT/EP2012/073237

§ 371 Date: May 20, 2015

(51) Int. Cl. B60S 1/38

(52) U.S. Cl. CPC B60S 1/3808; B60S 1/3887; B60S 1/3893

(57) ABSTRACT

A windscreen wiper device (1) of the flat blade type includes an elastic, elongated carrier element, as well as an elongated wiper blade (2) of a flexible material, which can be placed in abutment with a windscreen to be wiped. The wiper blade (2) includes at least one groove (3), in which groove (3) a longitudinal strip (4) of the carrier element is disposed. The free ends of the wiper blade (2) are connected to a respective end cap (8). A connecting device (5) for an oscillating wiper arm (6) is provided as well as a spoiler (7) at a side thereof facing away from the windscreen to be wiped. At least one end cap (8) includes a top surface (9) abutting a top surface (10) of the spoiler (7), and the top surface (9) of the end cap (8) and the top surface of the spoiler (7) extend in the same plane.

### BACKGROUND OF THE INVENTION

1. Technical Field

The present invention relates to a windscreen wiper device of the flat blade type comprising an elastic, elongated carrier element, as well as an elongated wiper blade of a flexible material, which can be placed in abutment with a windscreen to be wiped, which wiper blade includes at least one groove, in which groove a longitudinal strip of the carrier element is disposed, wherein free ends of the wiper blade are connected to a respective end cap, which windscreen wiper device comprises a connecting device for an oscillating wiper arm, and wherein the wiper blade is provided with a spoiler at a side thereof facing away from the windscreen to be wiped.

2. Related Art

Such a windscreen wiper device is generally known. The prior art windscreen wiper device is in particular designed as a “flat blade” or “yokeless blade”, wherein use is no longer made of several yokes pivotally connected to each other, but wherein the wiper blade is biased by the carrier element, as a result of which it exhibits a specific curvature.

One drawback of the prior art windscreen wiper device is the fact that the end caps and the wiper blade are not interconnected in a durable, solid and aerodynamic manner.

### SUMMARY OF THE INVENTION

The object of the invention is to overcome this drawback of the prior art as indicated above, in particular to provide a windscreen wiper device, wherein the wiper blade may not come loose from the end caps, and wherein the wiper blade has outstanding aerodynamic properties.

In order to accomplish that objective, a windscreen wiper device of the kind referred to in the introduction is characterized according to the invention in that at least one end cap comprises a top surface abutting a top surface of the spoiler, wherein the top surface of the end cap and the top surface of the spoiler extend in the same plane. In mounted position of the windscreen wiper device the plane extends parallel to a windscreen to be wiped. In the framework of the present invention the end cap at the location of its top surface does not extend beyond and above the top surface of the spoiler. Hence, the end cap and the wiper blade are interconnected in such a manner that the top surface of the end cap is flush with the top surface of the spoiler, so that the present windscreen wiper device has excellent aerodynamic properties. The wiper blade is particularly made of an elastomeric material through an extrusion operation.

As the end cap and the spoiler mutually have the same height (taking into account tolerances), the present windscreen wiper device locally has a very flat construction, so that in mounted position the windscreen wiper device does not interfere with other parts of a car and is hidden behind a bonnet thereof.

Further, the flat end cap ensures that in mounted position it does not interfere with channel-like part of an oscillating arm of the present windscreen wiper device. It is noted that the present invention is not restricted to windscreen wiper devices for cars, but that it also relates to windscreen wiper devices for rail coaches and all other (fast) vehicles.

In a preferred embodiment of a windscreen wiper device in accordance with the invention the end cap and the spoiler are flush-interconnected through a snapping operation, so that the top surface of the end cap and the top surface of the spoiler extend in the same plane. In use the plane extends parallel to a windscreen to be wiped.

In another preferred embodiment of a windscreen wiper device according to the invention the end cap is slid over one of the free ends of the wiper blade in a longitudinal direction thereof, wherein the top surface of the end cap comprises a horizontal slit open at one end, and wherein a part of the spoiler is slid inside the slit. the horizontal slit in the end cap is preferably realized through a specially designed mold. A molding operation ensures that the slit is locally formed in a reliable and controllable manner.

In another preferred embodiment of a windscreen wiper device in accordance with the invention the end cap is slid over one of the free ends of the wiper blade in a longitudinal direction thereof, wherein the spoiler is removed along a portion of the length of the wiper blade at the free end of the wiper blade so as to form an insertion part of the spoiler, and wherein the insertion part of the spoiler is slid inside the end cap. Particularly, a cutting operation is used to controllably and reliably remove the spoiler in part.

In another preferred embodiment of a windscreen wiper device according to the invention the end cap comprises engaging members sidewardly engaging the wiper blade from the outside, wherein the engaging members comprise retaining means for retaining the wiper blade onto the end cap. Particularly, the engaging members and the retaining means are in one piece.

Preferably, a molding operation would ensure that the engaging members and the retaining means can be formed in a reliable and controllable manner, without high costs as far as additional tools and equipment are concerned.

In another preferred embodiment of a windscreen wiper device according to the invention the engaging members and the retaining means are formed by inwardly bent parts of edges of lateral sides of the connecting piece.

In another preferred embodiment of a windscreen wiper device in accordance with the invention the retaining means comprise at least one sidewardly extending gripping tooth for gripping an intermediate web of the wiper blade. Particularly, the retaining means comprise at least two sidewardly extending, opposing gripping teeth.

### THE DRAWINGS

The invention will now be explained in more detail with reference to figures illustrated in a drawing, wherein:

FIG. 1 is a perspective, schematic view of a windscreen wiper device in accordance with the prior art;

FIG. 2 shows different views on an interconnection between an end cap and a spoiler used in the windscreen wiper device of FIG. 1; and

FIGS. 3 and 4 correspond to FIG. 2, with the difference that FIG. 3 refers to a first embodiment of the invention and FIG. 4 relates to a second embodiment of the present invention.

### DETAILED DESCRIPTION

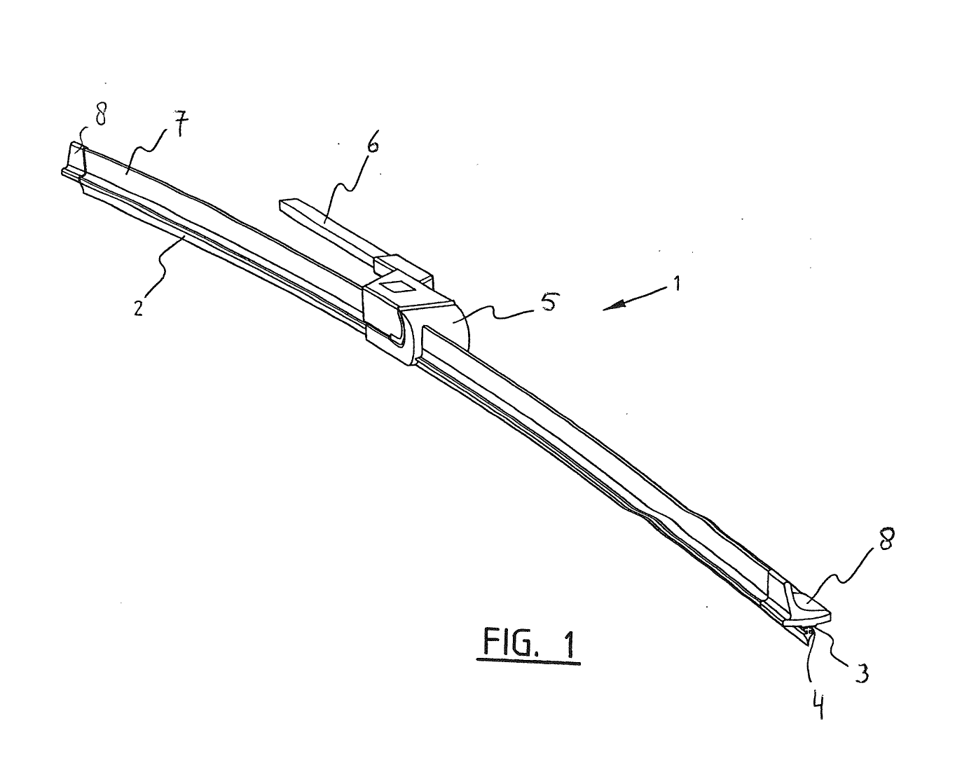

FIG. 1 shows a windscreen wiper device 1 according to the prior art. the windscreen wiper device 1 is built up of an elongated wiper blade 2 made of an elastomeric material. the wiper blade 2 comprises a central longitudinal groove 3, in which a longitudinal strip 4 or flexor made of spring band steel is fitted. the strip 4 forms a flexible carrier element for the rubber wiper blade 2, as it were, which is thus biased in a curved position (the curvature in operative position being that of a windscreen to be wiped).

The windscreen wiper device 1 is further equipped with a connecting device 5 for an oscillating arm 6, and a spoiler 7 made in one piece with the wiper blade 2. At both ends of the wiper blade 2, that is on either side of the windscreen wiper device 1, end caps 8 are provided.

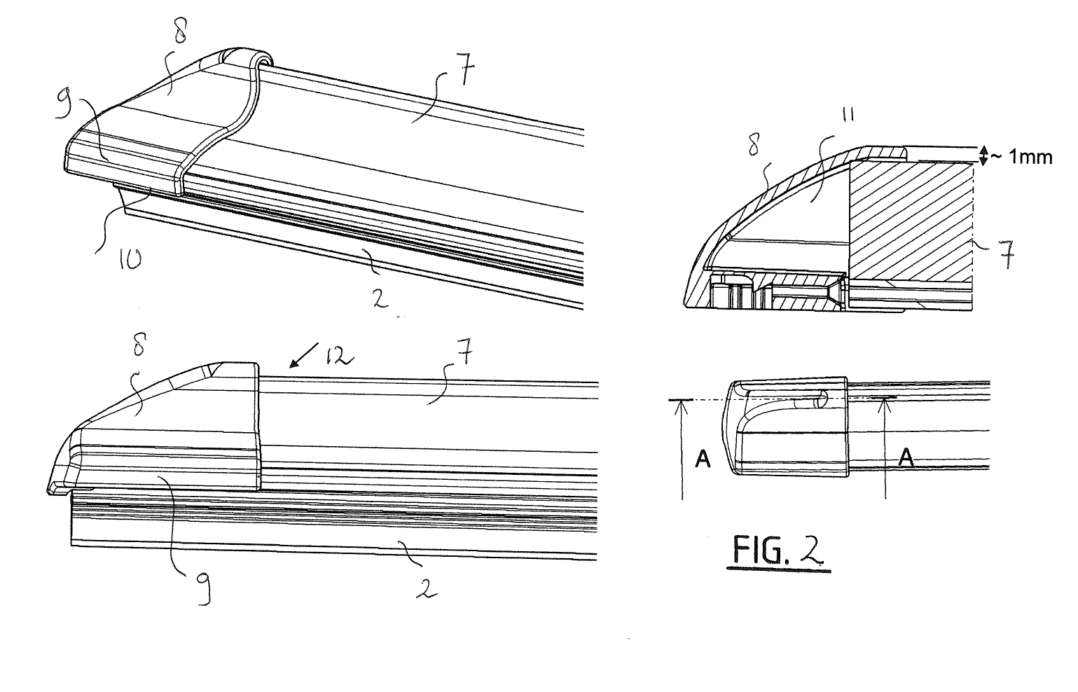

As can be seen in FIG. 2, lateral sides 9 of each end cap 8 are provided with engaging members 10 made integral therewith, wherein the engaging members 10 engage around an upper part of the wiper blade 2, so as to form a chamber 11 for sliding the upper part (including the spoiler 7) therein. the engaging means 10 may include sidewardly extending gripping teeth made integral therewith, wherein the gripping teeth grip into an intermediate web of the wiper blade 2. It is noted that the teeth may only slightly penetrate the elastomeric (rubber) material of the wiper blade 2, without damaging the same. As shown in FIG. 2 and designated with reference numeral 12, the end cap 8 covers a top of the spoiler 7, i.e. the end cap is fitted approximately 1 mm higher than the spoiler 7.

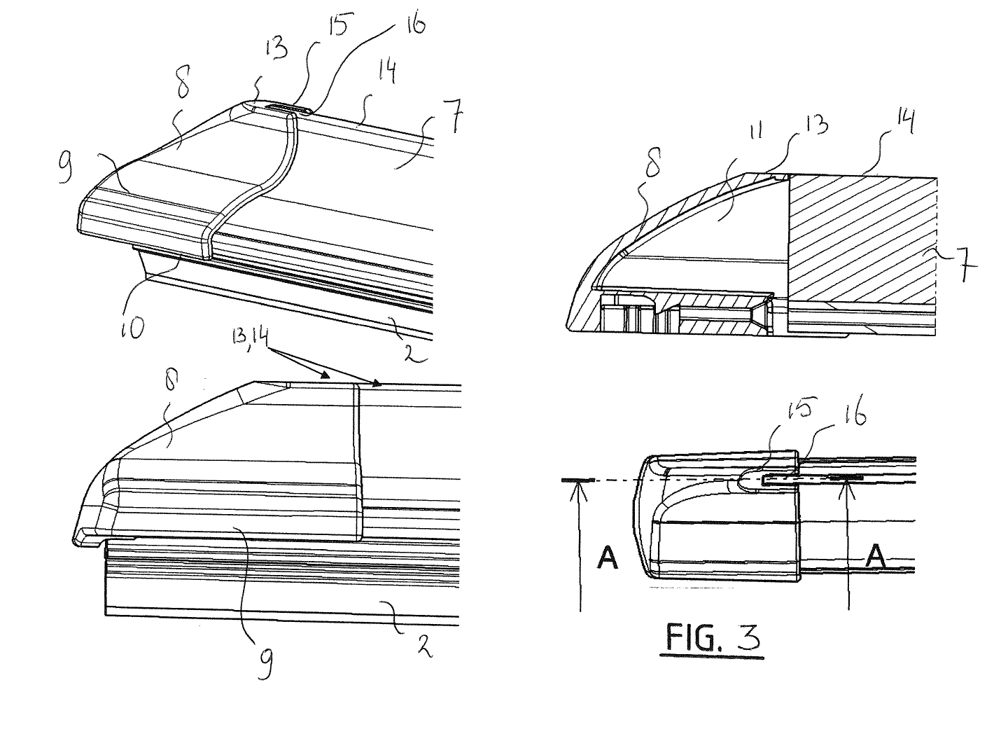

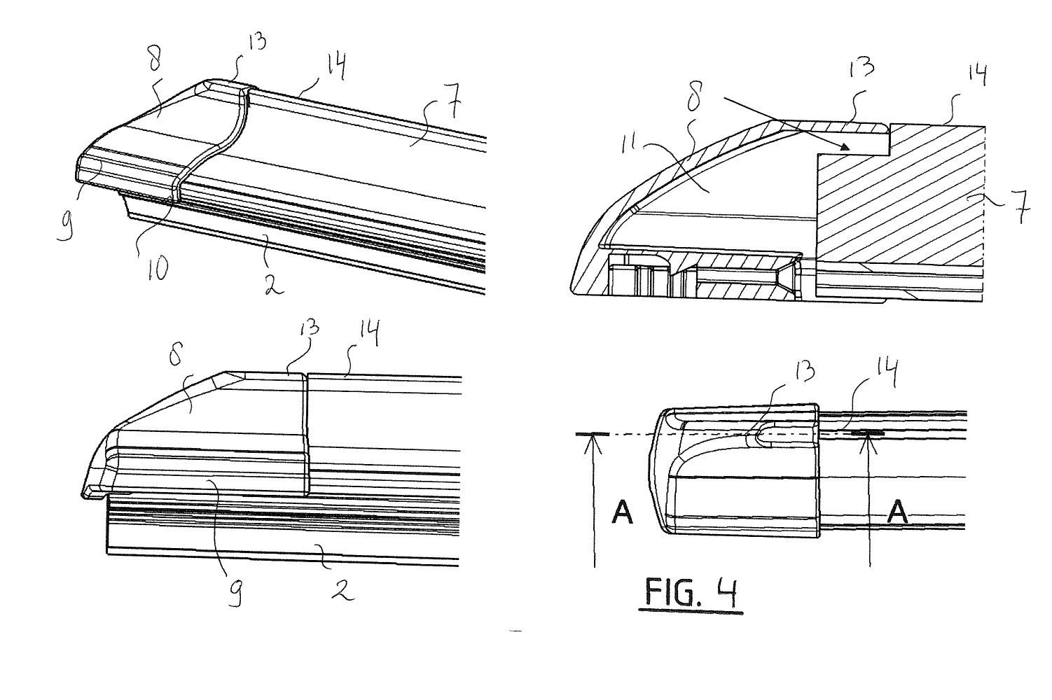

In FIGS. 3 and 4 two embodiments of end caps 8 according to the invention are depicted, respectively, wherein parts that correspond to parts of the end caps 8 of the prior art seen in FIGS. 1 and 2, are designated with the same reference numerals. In both embodiments of FIGS. 3 and 4 both end caps 8 each comprise a top surface 13 abutting a top surface 14 of the spoiler 7, wherein the top surface 13 of the end cap 8 and the top surface 14 of the spoiler 7 extend in one horizontal plane. Preferably, in both embodiments the end caps 8 and the spoiler 7 are flush-interconnected through a snapping operation, so that the top surface 13 of the end caps 8 and the top surface 14 of the spoiler 7 extend in one horizontal plane.

With reference to FIG. 3, the end cap 8 comprises the chamber 11 for sliding the upper part of the wiper blade 2 (including the spoiler 7) therein in a longitudinal direction thereof. As shown, the top surface 13 of the end cap 8 comprises a slit 15 open at one end, and wherein a part 16 of the spoiler 7 is slid inside the slit 15. Accordingly, the end cap 8 does not cover the spoiler 7 due to the fact that the end cap 8 and the spoiler 7 have the same height. As a consequence, there is no threshold at a location where the end cap 8 abuts the spoiler 7.

FIG. 4 corresponds to FIG. 3, wherein corresponding parts have been designated with the same reference numerals, on the understanding that in FIG. 4 the spoiler 7 is removed along a portion of the length of the wiper blade 2 at a free end of the wiper blade 2 so as to form an insertion part 17 of the spoiler 7. the insertion part 17 of the spoiler 7 is slid inside the chamber 11 of the end cap 8. Also in FIG. 4 the end cap 8 does not cover the spoiler 7 due to the fact that the end cap 8 and the spoiler 7 have the same height. Again, there is no threshold at a location where the end cap 8 abuts the spoiler 7.

As in both embodiments of FIGS. 3 and 4 the end caps 8 and the spoiler 7 mutually have the same height, the present windscreen wiper device 1 has a very flat construction, resulting in very good aerodynamic properties. Further, in mounted position the windscreen wiper device 1 does not interfere with other parts of a car and is hidden behind a bonnet thereof.

Although not shown in FIGS. 1 through 4, but fully understood by a skilled person, the oscillating arm 6 is connected to a mounting head fixed for rotation to a shaft driven by a small motor. In use, the shaft rotates alternately in a clockwise and in a counter-clockwise sense carrying the mounting head into rotation also, which in turn draws the oscillating arm 8 into rotation and by means of the connecting device 5 moves the wiper blade 2.

The invention is not restricted to the embodiments shown, but also extends to other preferred embodiments falling within the scope of the appended claims.

1. A windscreen wiper device of the flat blade type comprising an elastic, elongated carrier element, as well as an elongated wiper blade of a flexible material, which can be placed in abutment with a windscreen to be wiped, which wiper blade includes at least one groove, in which groove a longitudinal strip of the carrier element is disposed, wherein free ends of said wiper blade are connected to a respective end cap, which windscreen wiper device comprises a connecting device for an oscillating wiper arm, and wherein said wiper blade is provided with a spoiler at a side thereof facing away from the windscreen to be wiped, wherein at least one of said end caps comprises a top surface abutting a top surface of said spoiler, wherein said top surface of said at least one of said end caps and said top surface of said spoiler extend in the same plane.

2. The windscreen wiper device according to claim 1, wherein said at least one of said end caps and said spoiler are flush-interconnected through an elastic snapping operation, so that said top surface of said end cap and said top surface of said spoiler extend in the same plane.

3. The windscreen wiper device according to claim 1, wherein said at least one of said end caps is slid over one of said free ends of said wiper blade in a longitudinal direction thereof, wherein said top surface of said end cap comprises a slit open at one end, and wherein a part of said spoiler is slid inside said slit.

4. The windscreen wiper device according to claim 1, wherein said at least one of said end caps is slid over one of said free ends of said wiper blade in a longitudinal direction thereof, wherein said spoiler is removed along a portion of the length of said wiper blade at said free end of said wiper blade so as to form an insertion part of said spoiler, and wherein said insertion part of said spoiler is slid inside said end cap.

5. The windscreen wiper device according to claim 1, wherein said at least one of said end caps comprises engaging members sidewardly engaging said wiper blade from the outside, wherein said engaging members comprise retaining portions for retaining said wiper blade onto said end cap.

6. The windscreen wiper device according to claim 5, wherein said engaging members and said retaining portions are in one piece.

7. The windscreen wiper device according to claim 6, wherein said engaging members and said retaining portions are formed by inwardly bent parts of edges of lateral sides of said at least one of said end caps.

8. The windscreen wiper device according to claim 5, wherein said retaining portions comprises at least one sidewardly extending gripping tooth for gripping an intermediate web of said wiper blade.
